(19) United States
(12) Patent Application Publication
(10) Pub. No.: US 2018/0208267 A1
(43) Pub. Date: Jul. 26, 2018

(54) TRIPLE CONNECTION-STRUCTURED CRANK ARM EQUIPPED WITH BICYCLE PEDAL

(71) Applicant: Won Bo SIM, Seoul (KR)

(72) Inventor: Won Bo SIM, Seoul (KR)

(21) Appl. No.: 15/743,703

(22) PCT Filed: Feb. 10, 2017
(86) PCT No.: PCT/KR2017/001459

§ 371 Date: Jan. 11, 2018

(30) Foreign Application Priority Data
Mar. 22, 2016 (KR) 10-2016-0033834

(51) Int. Cl. B62M 3/02

(52) U.S. Cl. CPC B62M 3/02

(57) ABSTRACT

A triple connection-structured crank arm which can be applied to all types of conventional bicycles. The direction of the crank arm is adjustable throughout 360 degrees. When component crank arms are connected in a longer manner, speed can be utilized. In contrast, when the component crank arms are connected in a shorter manner, a corresponding bicycle can be utilized as an exercise bicycle.

### TECHNICAL FIELD

The present invention relates to a triple connection-structured crank arm equipped with a bicycle pedal, which enables a bicycle to be pedaled in a lighter manner based on the principle of a lever in which lightness increases as the length of a lever increases when component crank arms are connected in a longer, triple manner and then pedaling is performed, thereby allowing speed to be utilized, and which enables rotation to be performed in a heavier manner and thus enables a larger amount of physical energy to be consumed when the component crank arms are connected in a shorter, triple manner and then the bicycle is pedaled, thereby allowing the bicycle to be utilized for the purpose of exercise. The crank arm can be adjusted throughout 360 degrees, and can be always used.

In this case, the meaning of the term “pedaling” is as follows:

The pedaling relates to the height and radius of rotation of a bicycle which are most appropriate for a human to most efficiently rotate two pedals with two feet.

The most lengths of the crank arms of conventional bicycles are 175 millimeters. Although the length of the crank arm is about 250 millimeters in the present invention, the radius of rotation thereof is equal to 175 millimeters.

### BACKGROUND ART

[Document 1] U.S. Pat. No. 3,888,136 (Jun. 10, 1975)

[Document 2] JP 3091890 (Feb. 21, 2003)

Currently, there is no triple connection-structured crank arm equipped with a pedal, in which component bicycle crank arms are connected in a triple connection structure, and in which the triple connection-structured crank arm can be used to increase speed when component bicycle crank arms are connected in a longer manner and the triple connection-structured crank arm can be rotated in a heavier manner and used for the purpose of exercise when the component bicycle crank arms are connected in a shorter manner.

### DISCLOSURE

### Technical Problem

The lengths of the crank arms of the conventional bicycles are excessively short, and thus the effect of a lever cannot be effectively utilized. Furthermore, during pedaling, the radii of rotation of legs of humans are similar for all humans. Accordingly, when a crank arm is increased, inconvenience occurs during pedaling, and thus it is difficult to make further progress.

Moreover, there is no method by which component crank arms are connected in a shorter manner for the purpose of exercise and thus rotation is performed in a heavier manner during pedaling, thereby enabling a single crank arm to perform two functions.

### Technical Solution

The above problems are overcome by a triple connection-structured crank arm in which a catch, a spring, and a connection rod are applied to the connection rod of each component crank arm, component crank arms are connected and used in a longer manner and in a shorter manner, and the direction of a component crank arm can be adjusted throughout 360 degrees.

### Advantageous Effects

When the component crank arms are connected in a shorter manner, the pedals of a bicycle can be rotated in a lighter manner, and thus speed can be increased compared to the conventional crank arms. In contrast, when the component crank arms are connected in a shorter manner, the pedals are rotated in a heavier manner, and thus the bicycle can be used for the purpose of exercise. The crank arm can be applied to all types of bicycles.

### DESCRIPTION OF DRAWINGS

FIG. 1 <A> shows a conventional bicycle crank arm;

FIG. 1 <B> shows an inventive triple connection-structured crank arm;

FIG. 2 is an exploded view of an inventive product;

FIG. 3 is a partially cutaway view after assembly;

FIG. 4 <C> is a view showing a connection for the purpose of an increase in speed;

FIG. 4 <D> is a view showing a connection for the purpose of exercise; and

FIG. 5 is a view showing comparisons between the lengths of crank arms.

### DESCRIPTION OF REFERENCE SYMBOLS OF PRINCIPAL COMPONENTS IN THE ACCOMPANYING DRAWINGS

| | |
|---|---|
| 1: | first crank arm |
| 2: | second crank arm |
| 3: | third crank arm |
| 4: | pedal |
| 10: | home hole |
| 11: | spring |
| 12: | catch |
| 13, 14, 19, 20, 21: | catch paths |
| 15: | catch grip |
| 16: | catch grip hole |
| 17: | connection rod |
| 18: | connection rod pin groove |
| 18-1: | horseshoe-shaped connection |
| | rod fastening pin |
| 34: | mounting hole |
| 41: | screw threads |
| 100: | central point connection hole |
| A-A: | rear view of first crank arm |
| B-B: | rear view of second crank arm |
| C-C: | rear view of third crank arm |
| D-D: | sectional view of catch path |
| | of third crank arm |
| A: | speed pedaling line |
| B: | conventional pedaling line |
| K.: | exercise line |

### BEST MODE

The following description will be given with reference to the accompanying drawings:

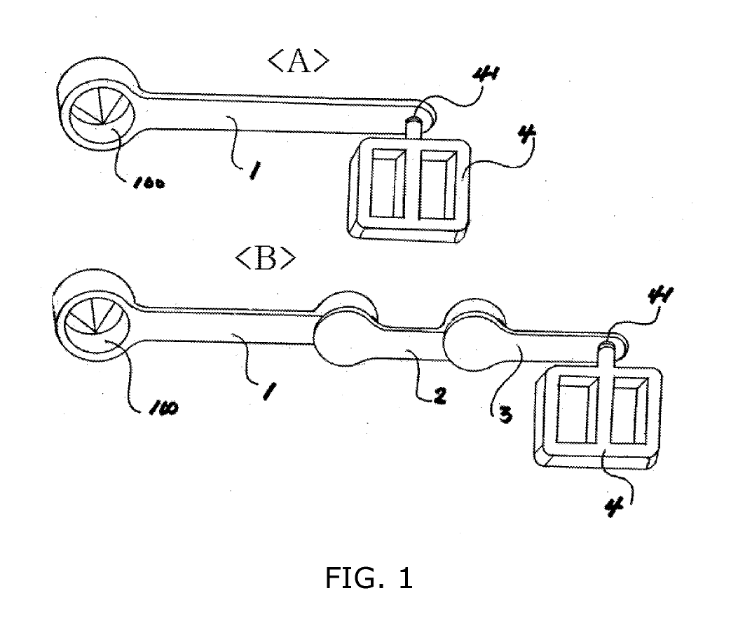

FIG. 1 <A> shows a conventional bicycle crank arm.

FIG. 1 <B> is a plan view of a triple connection-structured crank arm according to the present invention, in which a first crank arm 1, a second crank arm 2, and a third crank arm 3 are connected to one another in a triple manner, and a central point connection hole 100 configured to connect a crank arm, coupled to a pedal 4, to the sprocket of an conventional bicycle is provided. This is similar to the crank arm 1 of the conventional bicycle.

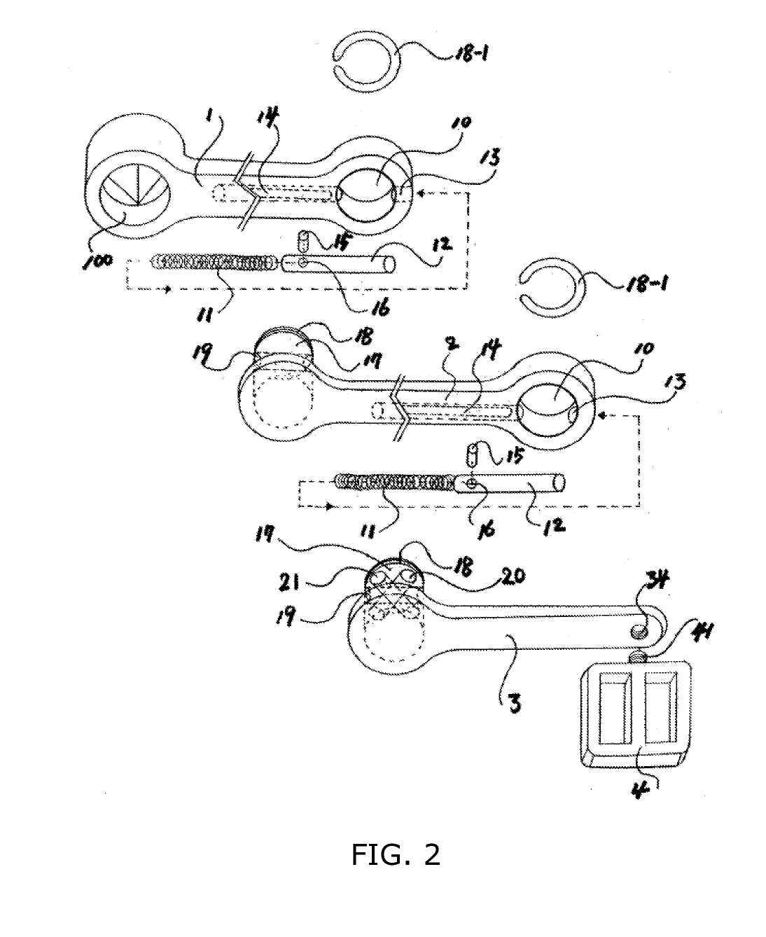

Referring to the exploded view of FIG. 2, methods of assembly and use are now described.

It is noted that the inventive product uses a double connection method, and thus the same portions using the same methods of assembly and use are designated by the same reference symbols.

A spring 11 and then a catch 12 are inserted into the holes of catch paths 13 and 14, into which the catch 12 is inserted, along dotted line arrows while traversing a home hole 10 formed through the first crank arm 1, a groove is formed in the back portion of the first crank arm 1 so that a catch grip 15 can move forward and backward along the catch path 14, and the catch grip 15 is inserted into a catch grip hole 16 and fastened in order to prevent the catch grip 15 from being separated therefrom. In this case, the catch 12 can move forward and backward inside the catch paths 13 and 14 without being separated from the catch paths 13 and 14.

When the connection rod 17 of the second crank arm 2 is inserted into the home hole 10, the connection rod 17 is inserted after pushing the catch grip 15 toward the spring 11 so that it is not stuck in the home hole 10. In order to prevent the connection rod 17 from being separated, a horseshoe-shaped connection rod fastening pin 18-1 is fitted and fastened into a connection rod pin groove 18, and the catch 12 is struck in the catch path 13 through the catch hole 19 of the connection rod 17 by the force of the spring 11 or by pushing the catch grip 15 with a hand. In this case, the first crank arm 1 and the second crank arm 2 are fastened and connected to each other in an integrated manner.

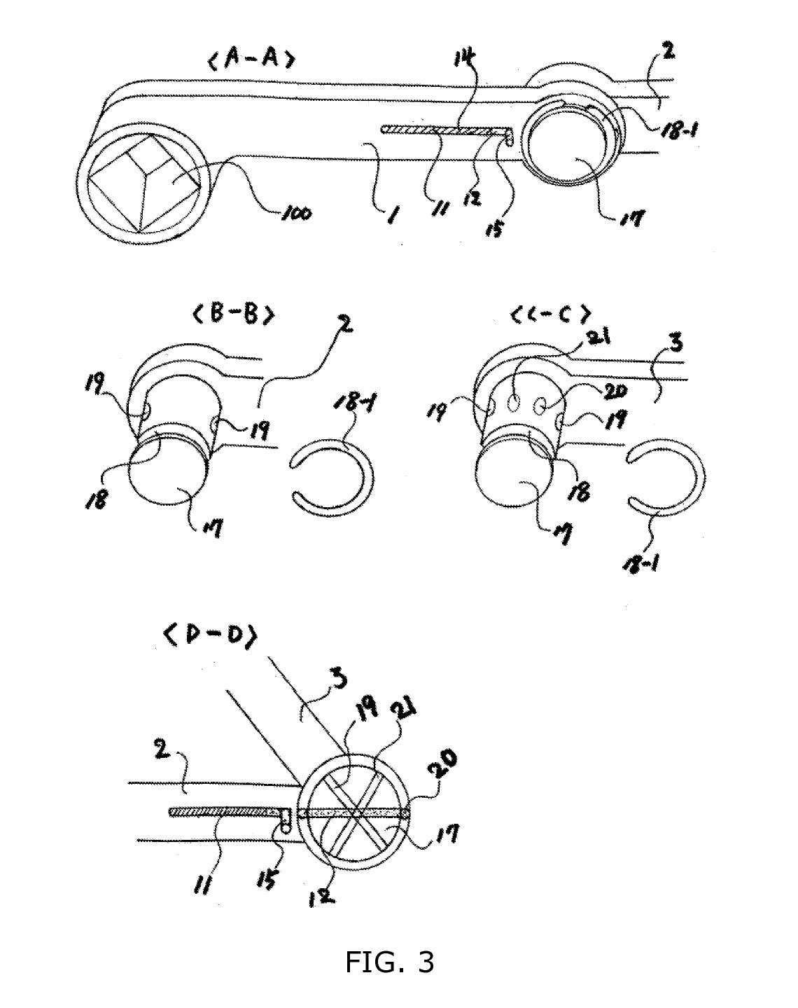

Reference is Now Made to the Rear View of FIG. 3 <A-A>.

When the second crank arm 2 is rotated by 180 degrees, the catch grip 15 of the catch 12 is pushed toward the spring 11, a connection rod 17 connected to the second crank arm 2 is rotated by 180 degrees in that state, and then the catch 12 is inserted into the catch path 13. In this case, 180 degree rotation and fastening have been performed, and thus the crank arm can be used.

Reference is now made to the catch hole 19 formed through the connection rod 17 in a lateral direction, which is shown in the rear view of FIG. 3 <B-B>.

It is noted that methods of assembling the second crank arm 2 and the third crank arm 3 are the same as described above and also reference symbols are the same as described above.

Catch paths 20 and 21 which are additionally disposed in the connection rod 17 of the third crank arm 3 are now described.

Since the third crank arm 3 requires an angle of about 45 degrees in order to selectively increase and decrease its length, the catch paths 20 and 21 are disposed in an X form in order to obtain the angle.

Reference is Now Made to the Rear View of FIG. 3 <C-C>.

For the purpose of greater understanding, the catch paths 19, 20 and 21 of FIG. 3 are described with reference to the rear view of FIG. 3 <D-D>.

The adjustment of the angle to 45 degrees, 180 degrees, or the like is performed by performing fastening while performing rotation by each path by using the catch 12 in the state in which the catch paths 19, 20 and 21 have been disposed in the connection rod 17 of the third crank arm 3.

The number of paths may be increased as desired.

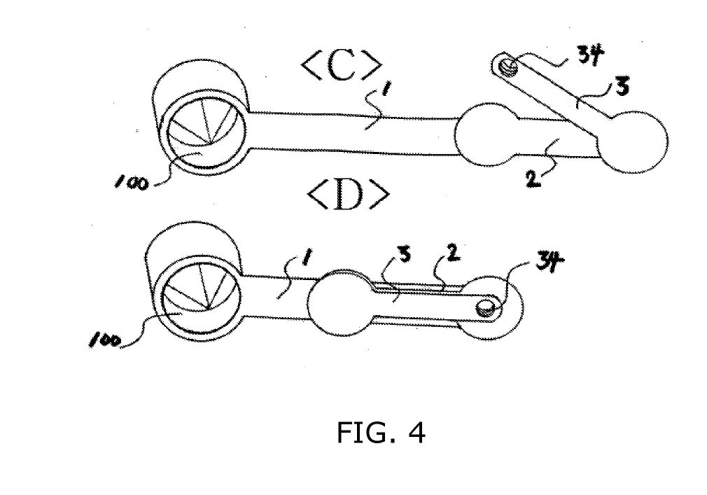

FIG. 4 <C>:

shows the angle at which light pedaling is enabled by adjusting the length and the angle through the rotation of the third crank arm 3 by 45 degrees, thereby increasing speed.

In greater detail,

only the third crank arm 3 has been rotated toward the center point connection hole 100 by about 135 degrees from the basic view of FIG. 1 <B> in which the first crank arm 1, the second crank arm 2, and the third crank arm 3 have been connected in a rectilinear line. The catch 12 is inserted into the catch path 20 of the third crank arm 3, adjustment to an angle of about 135 degrees is performed, and thus the pedaling line is adjusted in accordance with an conventional pedaling line, i.e., 175 millimeters, in the state in which the length the crank arm has been increased compared to the conventional crank arm.

The length of the crank arm refers to the length from the center of a pedal mounting hole 34 to the center of the central point connection hole 100. The length of the crack arm is adjusted to 175 millimeters by using the third crank arm 3 through the formation of an inside angle in order to reduce the length so the length of the crack arm becomes 175 millimeters, i.e., the length of the crank arms of the conventional bicycles.

When the pedal 4 is inserted into the pedal mounting hole 34 of the third crank arm adjusted such that the length of 175 millimeters is obtained and is rotated downward, a torque in a downward rotation direction is naturally concentrated on the connection portion of the third crank arm 3 at an inclination of about 45 degrees, and thus rotation is performed based on a length longer than that of the crank arms of the conventional bicycles. This utilizes the principle of a lever in which the load of the pedal decreases in proportion to the length.

FIG. 4 <D>:

shows a state for exercise in which the length of the crank arm is shorter than that of the crank arms of the conventional bicycles.

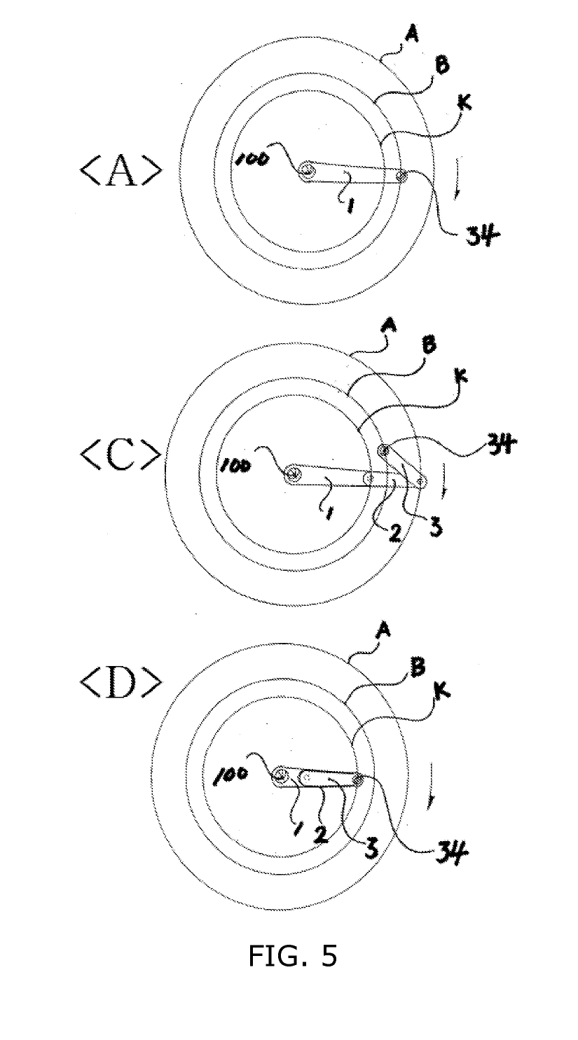

In FIG. 5, the shorter length of the crank arm according to the present invention is described through comparison with that of the conventional crank arm shown in FIG. 1 <A>.

FIG. 5 is a view showing comparisons between the rotations of crank arms.

The variations in the lengths of the inventive product and the conventional bicycle crank arm are compared and analyzed during rotation.

FIG. 5 <A> shows the crank arm of the conventional bicycle and a rotation line, i.e., line B.

In this case, a reference point is the mounting hole 34 in the same manner.

FIG. 5 <C> shows the state in which the principle of a lever is applied in proportion to the increased length of the crank arm, i.e., the length between line A and line B, and thus rotation is performed in a lighter manner, in order to increase speed compared to the conventional bicycle.

FIG. 5 <D> shows a method in which the crank arm is folded and becomes shorter, and the crank arm is rotated in a heavier manner, thereby enabling the bicycle to be used for the purpose of exercise. In this case, the lever is applied in proportion to the decreased length between line B and line K, and thus the pedal of the bicycle is rotated in a heavier manner, thereby enabling the bicycle to be used for a bicycle for exercise.

### INDUSTRIAL APPLICABILITY

Although the inventive product may be applied to all types of bicycles, the inventive product is preferably installed at a height obtained by increasing the distance between the pedal of the conventional bicycle and a ground surface by about 30 millimeters in order to achieve the true value of the inventive product. In this case, all types of bicycles can be changed such that the difference with respect to the conventional bicycles can be felt, thereby increasing industrial efficiency.

1. A triple connection-structured crank arm equipped with a bicycle pedal, the crank arm comprising:
a first crank arm, a second crank arm rotatably connected to the first crank arm, and a third crank arm rotatably connected to the second crank arm; and
fastening means configured to fasten each of the crank arms at a desired rotation angle in order to set a required length;
wherein each of the fastening means comprises:
a connection rod provided at an end of one of the crank arms, inserted into a rotational center of another one of the crank arms, and configured to rotate;
a plurality of catch holes provided through the connection rod;
a catch configured to be inserted into one of the plurality of catch holes and to fasten the connection rod;
a catch path provided inside each of the crank arms, and configured such that the catch is slidable therethrough; and
a spring provided inside the catch path, and configured to fasten the catch in the catch hole by means of its elasticity.
